(19) United States
(12) Patent Application Publication
(10) Pub. No.: US 2006/0108129 A1
(43) Pub. Date: May 25, 2006

(54) Hole Coring Apparatus

(76) Inventor: John Van Denham, Victoria (AU)

Correspondence Address: ROGER A JACKSON, ESQ, 800 PENNSYLVANIA, SUITE 1504, DENVER, CO, 80203-3185, US

(21) Appl. No.: 10/908,334

(22) Filed: May 8, 2005

(30) Foreign Application Priority Data
Nov. 9, 2004 (AU) 2004229017

(51) Int. Cl. A01B 1/00

(52) U.S. Cl. 172/371

(57) ABSTRACT

An earth hole coring apparatus and method includes an open receptacle with a surrounding sidewall about an axis, with first and second open ends transverse to the axis defining a receptacle interior, and a first open end perimeter less than a second open end perimeter. An extension member with a proximal end adjacent to the sidewall and a distal end, positioned substantially parallel to the axis and a driving member adjacent to the extension member and receptacle positioned substantially transverse to the axis, offset to the extension member with a long and short extension. A handle adjacent to the extension member is substantially transverse to the axis located between the driving member and distal end, being approximately co planar to the driving member, and offset to the extension member having a long and short extension, the handle long extension opposite the driving member long extension related to the extension member.

### TECHNICAL FIELD

The present invention relates to an apparatus for creating holes in an earth surface for the purpose of transplanting plants from pots into the earth. More particularly, the present invention is a manual hole coring apparatus that utilizes counterbalancing forces from the operators hands and feet to increase the downward force that the operator can exert upon the apparatus into the earth's surface without the operator having to remove a foot from the earth's surface to enhance the operators stability.

### BACKGROUND OF INVENTION

The transplanting of plants from small pots of a diameter in the range of two to ten inches normally requires a hole to be bored, cord, or dug in the earth surface of a slightly greater diameter than that of the pot and up to a depth of approximately ten inches. In a domestic situation is the number of plantings required are relatively few and normally the holes are dug by means of a shovel or spade. If the earth is particularly difficult to dig because of stones or the earth composition or condition, a pick, mattock, or crowbar may be necessary to form the hole. This can be inconvenient and an apparatus that can form holes in such difficult earth would be desirable. Furthermore, when plantings are undertaken on a larger commercial scale as in the forestry industry, a more convenient and efficient hole creating apparatus is desirable.

It has long been recognized in the prior art the benefits of using a hole coring type of apparatus for creating holes in the earth surface for the purpose of transplanting plants from pots into the earth. A hole coring apparatus typically includes a hollowed tapered cylinder that penetrates the earth's surface with the narrow end of the taper, thus there is a coring affect of the earth that is gathered on the interior of the tapered cylindrical tube. There are three primary advantages to the tapered cylindrical tube; the first one is that the core of the earth in the interior of the tapered cylindrical tube as the earth inserts into the tube interior during penetration of the earth's surface expands slightly so that when the tapered cylindrical tube is removed from the earth's surface the core of earth will be retained within the interior of the cylinder, thus creating the hole in the earth's surface. Secondly, in addition, removal of the core of earth is easier because the core has the shape of a tapered cylinder and can be extracted on the end of the tapered cylinder that is the larger diameter. Thirdly, the other advantage of the tapered cylindrical tube is that removal of the tapered cylinder itself from the earth's surface is easier because as the taper expands as the cylinder is penetrated into the earth, thereupon removal of the tapered cylinder from the earth, side friction is eliminated against the exterior of the cylinder. The reason for this is that the outside surface of the tapered cylinder has expanded the size of the hole and the earth by the penetration of the cylinder to a diameter larger than the outside diameter of the tapered cylinder being removed. This is as compared to a straight sided cylinder that once penetrated into the earth's surface can be quite difficult to remove due to the high degree of friction of the earth against the outside diameter of the cylinder. Thus, do the due to the advantages of the hole coring apparatus it has been widely used especially in situations where the earth is soft and a high number of cored holes are created as a typical hole coring apparatus can then easily allow a single manual operator to create four hundred to five hundred holes in a day's time.

A few prior art examples for a typical hole coring apparatus would be a U.S. Pat. No. 5,826,668 to Kosmalski that discloses a square cut sod turf planting tool for the purpose of removing cored square sections of sod at a selected depth. Another example would be U.S. Pat. No. 2,612,725 to Casey that discloses a forming and cutting tool for creating holes to plant bulbs and the like. Interestingly, Casey utilizes a straight cylinder upon its outside diameter with the cylinder having a tapered inside diameter which would seem to be satisfactory for holding the core on the inside of the cylinder, however, adding the problem of the difficulty in removing the straight sided cylinder from the earth as the straight sided cylinder outside diameter having the aforementioned excessive friction with the earth. Yet, another example is U.S. Pat. No. 1,952,585 to Croasdale, Jr. et al. that discloses a planting tool somewhat similar to Casey, however, using a truly tapered cylinder for creating the earth's core to create the hole in the earth's surface. Croasdale, Jr. et al. also includes a one-sided foot rest to assist in having the tapered cylinder penetrate the earth's surface. A last example would be U.S. Pat. No. 6,386,294 B1 to Best that discloses a hole making apparatus utilizing a straight cylindrical coring element with the addition of a tamper plate that is slidably engaged on the interior of the cylinder to assist in removing the soil plug from the cylinder, note that when the interior of the cylinder is straight that the earth's core can be difficult to remove from the cylinder interior.

However, there is a problem with the use of a typical hole coring apparatus, in that it requires a substantial amount of force to get the tapered cylinder to penetrate the earth's surface, and this is especially so when the earth is comprised of rocks combined with highly compact soils making for fairly hard earth, which can make penetration of the earth's surface by the tapered cylinder almost impossible. Thus, it is typically required for a manual operator to use both their feet and hands upon the a hole coring apparatus to maximize the amount of manual force that can be exerted for penetrating the surface which is going to typically be equal the operators body weight. This creates another problem in that when the operator is entirely standing upon the hole coring apparatus in an attempt to get the tapered cylinder to penetrate the earth's surface the operator places themselves into an inherently unstable position as they are virtually standing on a pogo stick type arrangement, with all their weight placed upon the leading edge of the tapered cylinder that is not anchored into the earth's surface and with no other means of lateral support for the operator to secure or stabilize themselves. This is especially troublesome with young and old operators, or operators that are not as physically fit as they could be. The instability of the operator is further aggravated by some situations where the operator would be jumping up and down upon the hole coring apparatus to gain a benefit of kinetic impact energy from their body upon the hole coring apparatus to increase the force upon the tapered cylinder into the earth's surface.

What is needed is a hole coring apparatus that incorporates all the aforementioned benefits of the tapered cylinder both for the inside and the outside of the cylinder, while at the same time overcoming the previously mentioned problem of increasing the force, of being able to penetrate the tapered cylinder into the earth's surface without causing the operator to have an unstable and unsafe situation for themselves by trying to balance their entire body weight upon the top of the hole coring apparatus or even worse at the same time jumping up and down upon the hole coring apparatus. A hole coring apparatus is needed that can utilize the operator's body weight to increase the penetrating force of the tapered cylinder on the earth's surface without the drawback of compromising safety and stability of the operator themselves in using the hole coring apparatus.

### SUMMARY OF INVENTION

Broadly, the present invention of a hole coring apparatus for creating a desired void in an earth surface comprises an open receptacle having a longitudinal axis, the open receptacle including a surrounding sidewall positioned substantially symmetrical about the axis. The sidewall has a first open end and a second open end that are substantially transverse to the axis to define a receptacle interior, with the first open end having a perimeter that is less than a second open end perimeter. Also included is an extension member extending from a proximal end being adjacent to an exterior of the sidewall to a distal end, with the extension member being substantially parallel to the axis. Further included is a driving member adjacent to the extension member positioned substantially transverse to the axis near the receptacle, the driving member is offset in relation to the extension member by having a driving member long extension and an opposing driving member short extension, wherein the driving member long extension is longer than the driving member short extension.

Finally included is a handle adjacent to the extension member positioned substantially transverse to the axis located between the driving member and the distal end of the extension member. The handle is approximately co planar with the driving member, the handle is offset in relation to the extension member having a handle long extension and an opposing handle short extension, wherein the handle long extension is longer than the handle short extension such that the handle long extension is placed opposite of the driving member long extension in relation to the extension member.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of a hole coring apparatus assembly;

FIG. 2 shows a perspective view of an open receptacle with a substantially square sidewall;

FIG. 3 shows a perspective view of an open receptacle with a substantially circular sidewall;

FIG. 4 shows a perspective view of an open receptacle with a substantially rectangular sidewall;

FIG. 5 shows a perspective view of an open receptacle with a substantially elliptical sidewall;

FIG. 6 shows a perspective view of an operator using the hole coring apparatus assembly at initial penetration of an earth surface;

FIG. 7 shows a perspective view of the operator using the hole coring apparatus assembly after full penetration of the earth surface utilizing a single operator foot;

FIG. 8 shows a perspective view of the operator using the hole coring apparatus assembly after full penetration of the earth surface utilizing both of the operator's feet; and

FIG. 9 shows a perspective view of the hole coring apparatus assembly removed from the earth after full penetration of the earth surface with the hole coring apparatus assembly substantially retaining a cored earth plug.

### REFERENCE NUMBER IN DRAWINGS

20 Hole coring apparatus assembly
21 Proximal end of extension member
22 Extension member
23 Distal end of extension member
24 Driving member
25 Extension member length
26 Handle
27 Receptacle interior
28 Open receptacle
29 Longitudinal axis of open receptacle
30 Surrounding sidewall
31 Surrounding sidewall of substantially elliptical open receptacle
32 Hole cored in earth or void
33 Surrounding sidewall of substantially rectangular open receptacle
34 Cored earth plug
35 Surrounding sidewall of substantially square open receptacle
36 Earth surface
37 Surrounding sidewall of substantially circular open receptacle
38 Earth
39 Substantially square surrounding sidewall height
40 Cored earth hole depth
41 Substantially square receptacle second open end width
42 Cored earth hole width
43 Substantially square receptacle first open end width
44 Operator
45 Substantially square surrounding sidewall thickness
46 Operator left hand
48 Operator right hand
50 Operator left foot
52 Operator right foot
54 Total downward force
56 Operator right foot downward force
58 Operator left hand downward force
59 Surrounding sidewall overlap
60 First open end of open receptacle
61 Second open end of open receptacle
62 First open end perimeter
63 Second open end perimeter
64 Total upward force
65 Surrounding sidewall exterior
66 Driving member long extension
67 Surrounding sidewall leading edge blade
68 Driving member short extension
70 Handle long extension
72 Handle short extension
74 Right foot moment at support frame
76 Left hand moment at support frame
80 Substantially circular surrounding sidewall height
82 Substantially circular surrounding sidewall second open end diameter
84 Substantially circular surrounding sidewall first open end diameter
86 Substantially circular surrounding sidewall thickness
88 Substantially rectangular surrounding sidewall height
90 Substantially rectangular surrounding sidewall second open end width
92 Substantially rectangular surrounding sidewall second open end length
94 Substantially rectangular surrounding sidewall first open end width
96 Substantially rectangular surrounding sidewall first open end length
97 Substantially rectangular surrounding sidewall thickness
98 Substantially elliptical surrounding sidewall height
100 Substantially elliptical surrounding sidewall second open end major diameter
101 Substantially elliptical surrounding sidewall second open end minor diameter
102 Substantially elliptical surrounding sidewall first open end major diameter
103 Substantially elliptical surrounding sidewall first open end minor diameter
104 Substantially elliptical surrounding sidewall thickness

### DETAILED DESCRIPTION

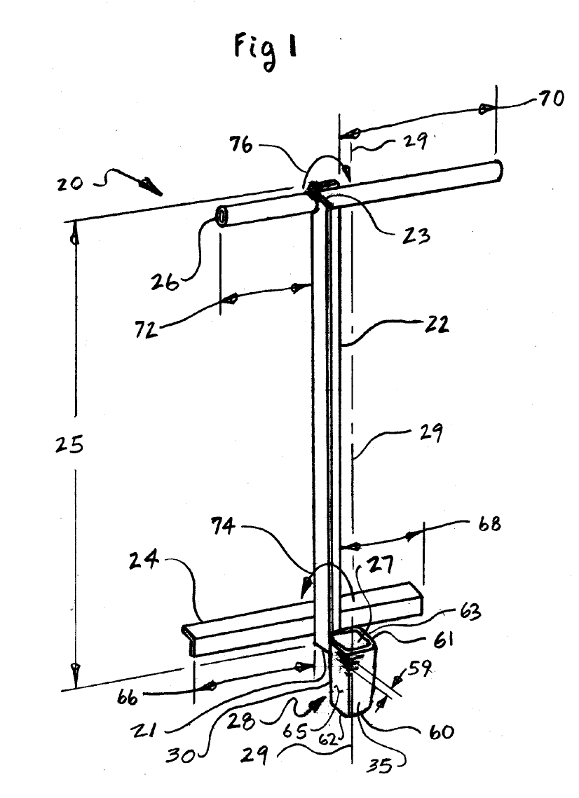

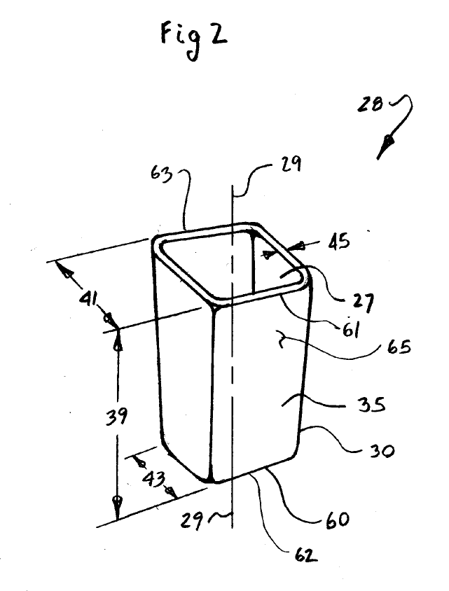

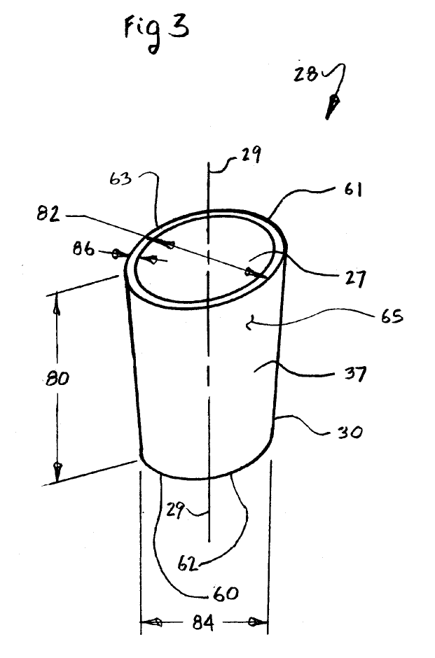

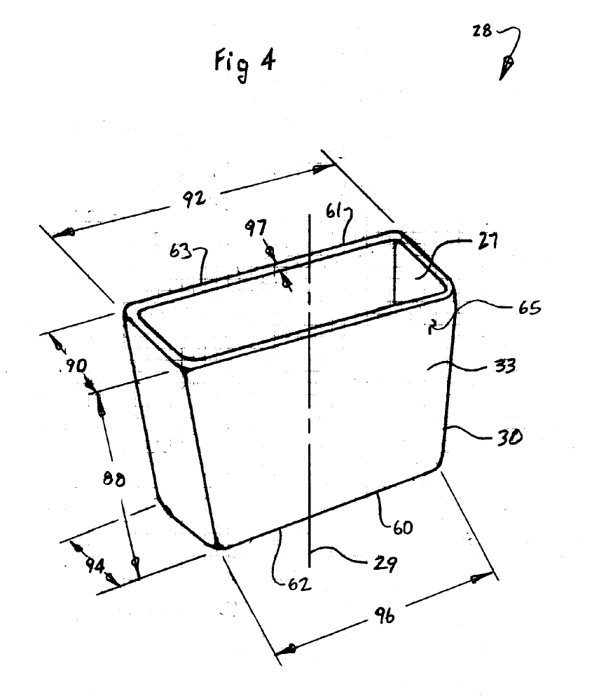

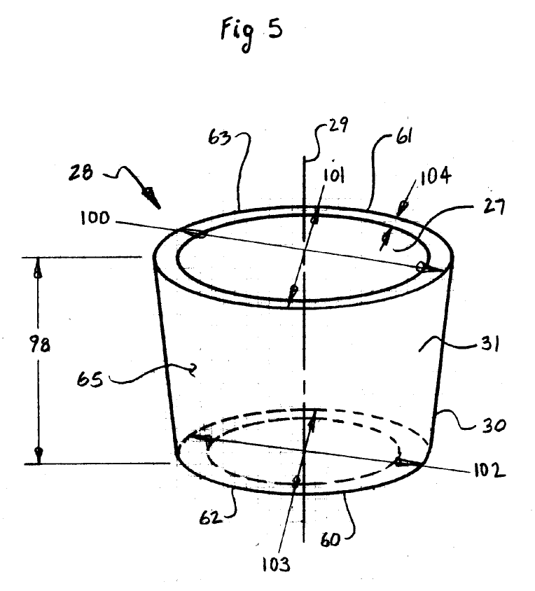

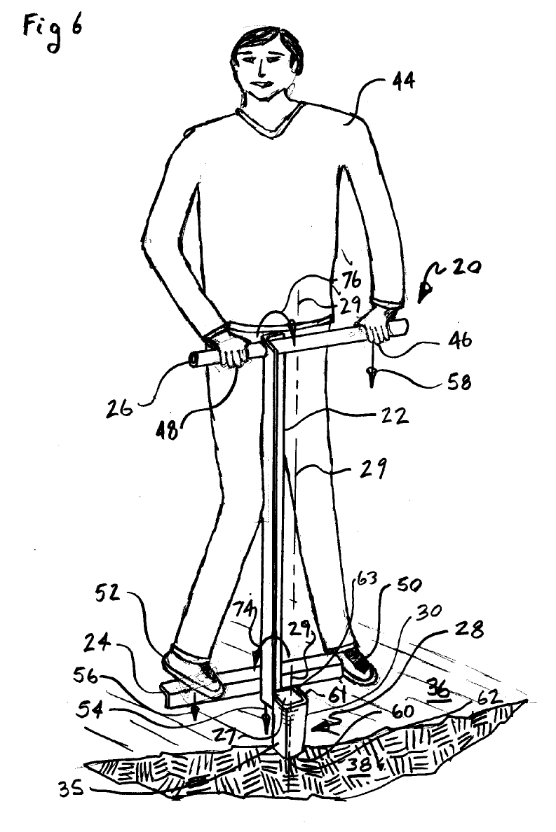

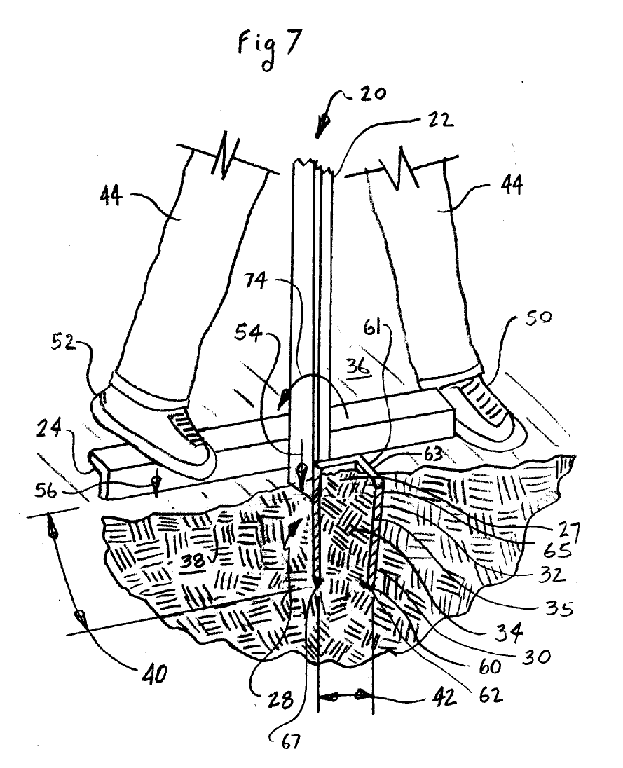

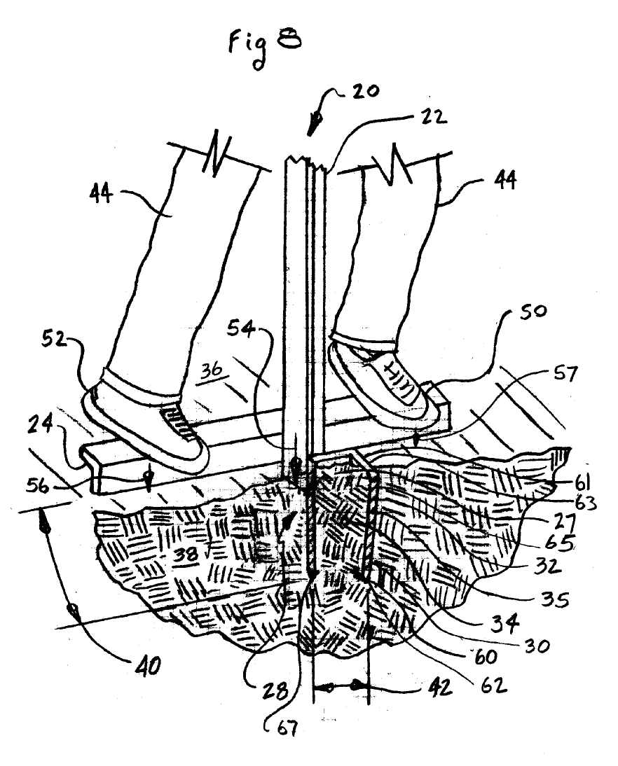

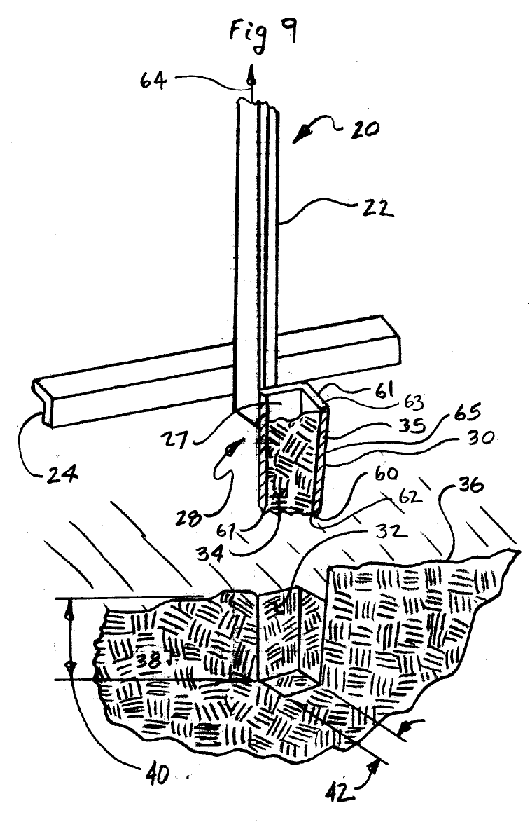

With initial reference to FIG. 1 shown is a perspective view of the hole coring apparatus assembly 20. FIG. 2 shows a perspective view of the open receptacle 28 with a substantially square sidewall 35. FIG. 3 shows a perspective view of the open receptacle 28 with a substantially circular sidewall 37. FIG. 4 shows a perspective view of an open receptacle 28 with a substantially rectangular sidewall 33. FIG. 5 shows a perspective view of an open receptacle 28 with the substantially elliptical sidewall 31. FIG. 6 shows a perspective view of the operator 44 using the hole coring apparatus assembly 20 at the initial penetration of an earth surface 36. FIG. 7 shows a perspective view of the operator 44 using the hole coring apparatus 20 after full penetration of the earth surface 36 utilizing a single operator right foot 52. FIG. 8 shows a perspective view of the operator 44 using the hole coring apparatus 20 after full penetration of the earth surface 36 utilizing both the right foot 52 and the left foot 50. FIG. 9 shows a perspective view of the hole coring apparatus 20 removed from the earth 38 after full penetration of the earth surface 36 with the hole coring apparatus 20 substantially retaining a cored earth plug 34.

Broadly, the present invention of the hole coring apparatus 20 for creating a desired void 32 in the earth surface 36 comprises an open receptacle 28 having longitudinal axis 29, with the open receptacle 28 including a surrounding sidewall 30 positioned substantially symmetrical about the axis 29. The sidewall 30 has a first open end 60 and a second open end 61 that are both substantially transverse to the axis 29 to define a receptacle interior 27, with the first opened end 60 having a perimeter 62 that is less than a second open end 61 perimeter 63. Also included is an extension member 22 that extends from the extension 22 proximal end 21 being positioned adjacent to the exterior 65 of the surrounding sidewall 30 to the extension member 22 distal end 23, with the extension member 22 being substantially parallel to the axis 29. Further included is the driving member 24 adjacent to the extension member 22 being positioned substantially transverse to the axis 29 near the receptacle 28, the driving member 24 is offset in relation to the extension member 22 having a driving member 24 long extension 66 and an opposing driving member 24 short extension 68, wherein the driving member 24 long extension 66 is longer than the driving member 24 short extension 68.

Finally, included in the hole coring apparatus 20 is a handle 26 adjacent to the extension member 22 positioned substantially transverse to the axis 29 located between the driving member 24 and the extension member 22 distal end 23. The handle 26 is approximately co planar with the driving member 24, with the handle 26 being offset in relation to the extension member 22, having a handle 26 long extension 70 and an opposing handle 26 short extension 72, wherein the handle 26 long extension 70 is longer than the handle 26 short extension 72 such that the handle 26 long extension 70 is placed opposite of the driving member 24 long extension 66 in relation to the extension member 22.

More particularly, the surrounding sidewall 30 can assume a number of different shapes depending upon manufacturing and cost requirements, in addition to the desired aspect ratio of the cored earth hole depth 40 relative to the cored hole width 42, also depending upon the desired shape or configuration of the surrounding sidewall 30 being substantially parallel to the first opened end perimeter 62 and the second open end perimeter 63 or in a plane substantially perpendicular to the axis 29. Preferably, the surrounding sidewall 30 is of a substantially square shape 35 in a plain perpendicular to the axis 29 as best shown in FIGS. 1, 2, 6, 7, 8, and 9. Alternatively, the surrounding sidewall 30 could be substantially elliptical 31 in shape in a plane perpendicular to the axis 29 as best shown in FIG. 5. Also, alternatively, the surrounding sidewall could be substantially circular 37 in a plane perpendicular to the axis 29 as best shown in FIG. 3. Further, alternatively the surrounding sidewall could substantially be rectangular 33 in shape in a plane perpendicular to the axis 29 as best shown in FIG. 4. The preferred materials of construction for the surrounding sidewall 30 or steel with a corrosion resistant coating such as galvanizing or powder coating and the like, alternatively the materials of construction for the surrounding sidewall 30 could be stainless steel or a plastic suitable for coring earth 38.

Continuing on the surrounding sidewall 30, the preferred dimensions for the substantially square surrounding sidewall 35 open receptacle and in referring particularly to FIG. 2, are for the height 39 about 5.3 inches, for the second open end width 41 about 2.3 inches, for the first opened end width 43 about 1.7 inches, and for the thickness 45 about 0.060 inches. Further, continuing on the surrounding sidewall 30, the preferred dimensions for the substantially circular surrounding sidewall 37 open receptacle and in referring particularly to FIG. 3, are for the height 80 about 5.3 inches, for the second open end diameter 82 about 2.3 inches, for the first open end diameter 84 about 1.7 inches, and for the thickness 86 about 0.060 inches. Next, on the surrounding sidewall 30 the preferred dimensions for the substantially rectangular surrounding sidewall 33 open receptacle, and in referring particularly to FIG. 4, are for the height 88 about 5.3 inches, for the second open end width 90 about 2.3 inches, for the second open end length 92 about 4.6 inches, for the first open end width 94 about 1.7 inches, for the first open end length 96 about 3.4 inches and for the thickness 97 about 0.060 inches.

Yet, further continuing on the surrounding sidewall 30, the preferred dimensions for the substantially elliptical surrounding sidewall 31 open receptacle, and in referring particularly to FIG. 5, are for the height 98 about 5.3 inches, for the second open end major diameter about 4.6 inches, for the second open end minor diameter 101 about 2.3 inches, for the first opened in major diameter 102 about 3.4 inches, the first open end minor diameter 103 about 1.7 inches, and for the thickness 104 about 0.060 inches. Note, that for the surrounding sidewall 30, other sizes and configurations would be acceptable as desired for the size and configuration of the void 32, as long as a core 34 of earth 38 were removed from the earth's surface 36. As the surrounding sidewall 30 is adjacent to the extension member 22, the preferred attachment of the surrounding sidewall 30 to the extension member 22 is by conventional welding as best shown in FIG. 1, with the surrounding sidewall 30 overlap 59 of about 0.6 inches with the overlap 59 being more or less depending upon the size and configuration of both the surrounding sidewall 30 and the extension member 22. However, other attachment methods with the acceptable such as bolting, screwing, adhesives, threading, slip or shrink fit, and the like as long as the strength of the attachment between the surrounding sidewall 30 and the extension member 22 is adequate for the operator right foot 52 downward force 56 (as best shown in FIGS. 6 and 7) and the operator 44 left hand 46 downward force 58 both to be transmitted from the operator 44 to the extension member 22 and to the surrounding sidewall 30 through a total downward force 54. Also, optionally, on the surrounding sidewall 30 the first open end perimeter 62 were the first open end of the open receptacle 60 can be formed into a leading edge 67 (as best shown in the FIGS. 7, 8, and 9) to ease penetration of the first opened end 60 of the open receptacle into the earth 38 surface 36.

Moving in detail to the handle 26 which is preferably constructed of carbon steel round tube stock with a corrosion resistant coating such as galvanizing, or powder coating, and the like, the handle 26 has an outside diameter of about 0.9 inches and an inside diameter of about 0.6 inches, however, other outside and inside diameters and materials of construction would be acceptable as long as the tube outside diameter was sized and configured for the operator's 44 left hand 46 and right hand 48, with the handle 26 having adequate strength for the operator's 44 left hand 46 downward force 58 and the resultant moment 76 as best shown in FIG. 6. Further, on the handle 26 (as best shown in FIG. 1) which is adjacent to the extension member 22 and with the handle 26 positioned substantially transverse to the extension member 22, the handle 26 is also offset in relation to the extension member 22 wherein in the handle 26 long extension 70 being preferably about 10.8 inches and the handle 26 opposing short extension 72 being preferably about 4.9 inches. Note that both the handle 26 long extension 70 and the handle 26 short extension 72 could each be longer or shorter depending upon the operator 44 left hand 46 and operator 44 right hand 48 sizes, operator 44 shoulder width, operator 44 left and right arm length, also the hardness and/or density of the earth 38, and other factors that could affect the desired handle 26 long extension 70 length and the handle 26 short extension 72 length, however, with the need for the handle 26 long extension 70 being longer than the handle 26 short extension 72, as will be explained in the method of use section of the description. As the handle 26 is adjacent to the extension member 22, the preferred attachment of the handle 26 to the extension member 22 is by conventional welding. However, other attachment methods would be acceptable such as bolting, screwing, adhesives, threading, slip or shrink fit, and the like as long as the strength of the attachment between the handle 26 and extension member 22 is adequate for the operator left hand 46 downward force 58(as best shown in FIG. 6) to be transmitted from the operator 44 to the extension member 22 both as a total downward force 54 and as an operator 44 left hand 46 moment 76 as a total combined load to the attachment between handle 26 and the extension member 22.

Next, moving in detail to the extension member 22 and referring specifically to FIG. 1, the extension member 22 preferred materials of construction are conventional carbon steel angle iron with a corrosion resistant coating such as galvanizing, or powder coating, and the like, the extension member 22 is preferably conventional carbon steel angle iron sized at 1.2 inches by 1.2 inches by 0.12 inches wall thickness with a preferred length 25 of about 30 inches. Alternative materials of construction and the size and configuration of the extension member 22 would be acceptable as long as the strength of the extension member 22 is adequate for the operator left hand 46 downward force 58 (as best shown in FIG. 6) to be transmitted from the operator 44 to the extension member 22, both as a total downward force 54 and as an operator 44 left hand 46 moment 76 as a total combined load to the extension member 22. In addition, the extension member 22 would need to have adequate strength to accommodate the operator right foot 52 downward force 56 (as best shown in FIGS. 6 and 7) to be transmitted from the operator 44 to the extension member 22 by way of the driving member 24, both as a total downward force 54 and as an operator 44 right foot 52 moment 74 as a total combined load to the attachment between the driving member 24 and the extension member 22.

Continuing, on the driving member 24 (as best shown in FIG. 1) which is adjacent to the extension member 22 and with the driving member 24 positioned substantially transverse to the extension 22, the driving member 24 is also offset in relation to extension member 22, wherein there is the driving member 24 long extension 66 which is preferably about 6.5 inches and the opposite driving member 24 short extension 68 which is preferably about 5.3 inches. Note that both the driving member 24 long extension 66 and the driving member 24 short extension 68 could each be longer or shorter depending upon the operator 44 left foot 50 and operator 44 right foot 52 sizes, operator 44 left and right leg length, also hardness and/or density of the earth 38, and other factors that could affect the desired driving member 24 long extension 66 length and the driving member 24 short extension 68 length, however, the need for the driving member long extension 66 being longer than the driving member 24 short extension 68, as will be explained in method of use section of the description. Note that the driving member 24 short extension 68 could be optional, in other words there could be no driving member 24 short extension 68 with the driving member 24 long extension 66 only being present, depending upon whether the operator 44 uses both the left foot 50 and the operator 44 right foot 52 (as best shown in FIG. 8) which would require the driving member 24 long extension 66 and the driving member 24 short extension 68 or the operator 44 uses only the right foot 52(as best shown in FIGS. 6 and 7) or alternatively only the left foot 50 (not shown) requiring only the driving member 24 long extension 66 without the driving member 24 short extension 68. Note also that at shown in FIG. 1, the driving member 24 option for only the long extension 66 without the driving member 24 short extension 68 could be opposite from what is shown in FIG. 1, with the driving member 24 long extension 66 extending alone opposite from extension member 22 from what is shown in FIG. 1.

As the driving member 24 is adjacent to the extension member 22, the preferred attachment of the driving member 24 to the extension member 22 is by conventional welding. However, other attachment methods would be acceptable such as bolting, screwing, adhesives, slip or shrink fit, and the like as long as the strength of the attachment between the driving member 24 and the extension member 22 is adequate for the operator right foot 52 downward force 56 (as best shown in FIGS. 6 and 7) to be transmitted from the operator 44 to the extension member 22, both as a total downward force 54 and as an operator 44 right foot 52 moment 74 as a total combined load to the attachment between the driving member 24 in the extension member 22. Further, in detail on the driving member 24 and again referring specifically to FIG. 1, the driving member 24 preferred materials of construction are conventional carbon steel angle iron with a corrosion resistant coating such as galvanizing, powder coating, and the like, the driving member 24 is preferably conventional carbon steel angle iron sized at 1.2 inches by 1.2 inches by 0.12 inches wall thickness. Alternative materials of construction and the size and configuration of the driving member 24 would be acceptable as long as the strength of the driving member 24 is adequate for the operator 44 right foot 52 downward force 56 (as best shown in FIGS. 6 and 7) to be transmitted from the operator 44 to the driving member 24, both as a total downward force 56 and as an operator 44 right foot 52 moment 74 as a total combined load to the driving member 24. Optionally, the driving member 24 can be positioned to be substantially co planar with the second open end 61 of the open receptacle (as best shown in FIGS. 7 and 8), wherein the driving member 24 is operational to limit penetration of the open receptacle 28 into the earth 38 surface 36 by the driving member 24 contacting the earth 38 surface 36.

Depending upon the preference of the operator 44 and in referring to FIG. 1, the handle 26 long extension 70 and the handle 26 short extension 72 could be oppositely disposed in relation to the extension member 22 from what is shown and likewise on the driving member 24 the long extension 66 and a short extension 68 could be oppositely disposed from what is shown, or as previously described having only the driving member 24 long extension 66 only without the short extension 68 oppositely disposed from what is shown.

### Method of Use

A method is disclosed for creating a desired void 32 in an earth 38 surface 36 with the operator 44 manually using the hole coring apparatus assembly 20, comprising the following steps of first providing a hole coring apparatus assembly 20 that includes an open receptacle 28 with a longitudinal axis 29, an extension member 22 extending from the extension member 22 proximal end 21 being adjacent to the open receptacle 28 to the extension member 22 distal end 23. Also included in the hole coring apparatus assembly 20, the extension member 22 is substantially parallel to the axis 29, with the driving member 24 being adjacent to the extension member 22, and the driving member 24 being positioned substantially transverse to the axis 29 near the open receptacle 28. The driving member 24 is offset in relation to the extension member 22, wherein the driving member 24 includes a driving member 24 long extension 66 and an opposing driving member 24 short extension 68, additionally, there is the handle 26 that is adjacent to the extension member 22, with the handle member 22 being positioned substantially transverse to the axis 29, with the handle member 22 being located between the driving member 24 and the extension member 22 distal end 23. The handle 26 is approximately co planar with the driving member 24 (as best shown in FIG. 1), with the handle 26 being offset in relation to the extension member 22, with the handle 26 including a handle 26 long extension 70 and an opposing handle 26 short extension 72, such that the handle 26 long extension 70 is placed opposite of the driving member 24 long extension 66 in relation to the extension member 22 (also as best shown in FIG. 1).

A next step is in positioning the open receptacle 28 of the hole coring apparatus assembly 20 to a selected location on the earth 38 surface 36 wherein the desired void 32 is to be located on the earth 38 surface 36. Continuing, a further step is placing the right foot 52 of the operator 44, upon the driving member 24 long extension 66 by bending the right knee of the operator 44, while leaving the left foot 50 of the operator 44 to remain on the earth 38 surface 36 by having the operator's left leg extended, wherein the operator's 44 stability is enhanced on the earth 38 surface 36 (as best shown in FIG. 6). Yet further, a next step is placing the left-hand 46 of the operator 44 upon the handle 26 long extension 70 with the left arm of the operator 44 extended (as best shown by combining FIGS. 1 and 6). Next, the operator 44 engages in placing the right hand 48 upon the handle 26 short handle extension 72 by bending the operator's 44 right arm elbow (again as best shown by combining FIGS. 1 and 6). At this point the next step for the operator 44 is to engage in applying a total downward force 54 by the operator 44, with the total downward force 54 being created by the operator 44 by simultaneously applying force 56 on the right foot 52 of the operator 44 upon the driving member 24 long extension 66 and a downward force 58 on the left-hand 46 of the operator 44 upon the handle 26 long extension 70, wherein the open receptacle 28 penetrates the earth 38 surface 36 with the axis 29 being substantially perpendicular to the earth 38 surface (as best shown in FIGS. 1 and 6).

Note that in referring in particular to FIG. 6, that the moment 76 created by the operator's 44 left hand force 58 on the handle 26 long extension 70 that translates into the extension member 22 and the moment 74 created by the operator's 44 right foot 52 force 56 on the driving member 24 long extension 66 into the extension member 22 act to substantially cancel each other out resulting in a total downward force 54 on the extension member 22 that further translates into the open receptacle 28 to penetrate the earth 38 surface 36. The helpful benefit of the substantially canceling moments 76 and 74 is to allow for a higher downward force 54 while at the same time helping the operator 44 retain some degree of stability on the earth 38 surface 36 while driving or penetrating the open receptacle 28 into the earth 38 surface 36, this is as opposed to the operator 44 using for instance a conventional shovel wherein there is no offset to the moment created by the operator 44 applying force with one foot to one side of the shovel resulting in a lower penetrating force for the shovel to pierce the earth or 38 surface 36, especially in hard compact dry earth 38. If, while using a conventional shovel the operator 44 attempts to use both the right foot 52 and the left foot 50 on the shovel, with one foot on each side of the shovel handle to increase the downward force on the shovel to more easily penetrate the earth 38 surface 36, the stability of the operator 44 is greatly decreased as the operator 44 has no contact with the earth 38 surface 36 resulting in a higher potential risk for injury from falling.

Further, the next step is in continuing the downward force 54 on the right foot 52 and the downward force 58 with the left hand 46 until the open receptacle 28 penetrates the earth 38 surface 36 to a selected core hole depth 40 (as best shown in FIG. 7). A final step of removing the hole coring apparatus assembly 20 from the earth 38 surface 36 is by applying an upward force on the handle 26 from the left 46 and right 48 hands of the operator 44 resulting in total upward force 64, wherein upward force 64 should be of a lower magnitude than the total downward force 54 due to the open receptacle 28 having the first open end 60 with a perimeter 62 that is less than the second open in 61 perimeter 63 resulting in the surrounding sidewall 30 having a slight taper inward from the second open end 61 to the first open end 60. Thus, as the open receptacle 28 is withdrawn from the earth 38 (as best shown in FIG. 9) there is substantially no frictional contact between the surrounding sidewall 30 exterior 65 and the earth 38, subsequently resulting in the desired void 32 being created in the earth 38 surface 36 in such that a cored earth plug 34 is substantially retained by the open receptacle 28. The final result is in the void 32 receiving a root ball from a tree or a plat for planting in the earth 38.

Referring in particular to FIG. 7, optionally the aforementioned step of continuing the downward force 54 is continued until the driving member 24 contacts the earth 38 surface 36, basically using the driving member 24 to earth 38 surface 36 contact as a gage to set the cored hole depth 40, resulting in the cored hole depth 40 being consistent from void 32 to void 32 when using the hole coring apparatus assembly 20 for a plurality of voids 32 to be created on the earth 38 surface 36 in a row or other pattern. Note that when the hole coring apparatus 20 is used for a plurality of voids 32, the core 34 from the previous void 32 will be driven out by the subsequent core 34 that forms the subsequent void 32 and continuing onward. Also, as an option and in referring particularly to FIG. 8, the aforementioned step of continuing the downward force 54 is continued using both the operator's 44 right foot 52 and left foot 50 on the driving member 24 long extension 66 and short extension 68 respectively, being operational to further increase the downward force 54 to accommodate especially hard compact dry earth 38. In order to overcome the aforementioned operator stability problem by not having at least either the operator's 44 right foot 52 when the left foot 50 on the earth 38 surface 36 during the step of continuing the downward force 54, the placing of the operator's 44 right foot 52 and left foot 50 on the driving member 24 as described above should not be done until the open receptacle 28 is at least partially penetrated into the earth 38 surface 36 to allow the open receptacle 28 to have some measure of lateral or axis 29 stability for the operator 44 to remove both the right foot 52 and/or left foot 50 the earth 38 surface 36 and onto the driving member 24 as previously described.

The above described method of use, referring particularly to FIG. 6, can also be applied in an opposite handed and footed sense in that instead of placing the operator 44 right foot 52 on the driving member 24 long extension 66 and keeping the operator 44 left foot 50 on the earth 38 surface 36, the operator 44 could place their left foot 50 on the driving member 24 long extension 66 and keeping the operator 44 right foot 52 on the earth 38 surface 36, this could be accomplished either by the operator 44 facing the opposite side of the hole coring apparatus 20 than as shown in FIG. 6, or by having the driving member 24 long extension 66 and short extension 68 reversed in relation to the extension member 22. In a like manner, instead of the operator 44 placing their left hand 46 on the handle 26 long extension 70 and their right hand 48 on the handle 26 short extension 72, the operator 44 could place their right hand 48 on handle 26 long extension 70 and their left hand 46 on the handle 26 short extension 72 again either by the operator 44 facing the opposite side of the hole coring apparatus 20 than as shown in FIG. 6, or by having the handle 26 long extension 70 and short extension 72 reversed in relation to the extension member 22. The operator 44 would then use the hole coring apparatus 20 as previously described reversing the left hand 46 and right hand 48 use and the operator 44 left foot 50 and right foot 52 use.

### CONCLUSION

Accordingly, the present invention of a hole coring apparatus assembly 20 has been described with some degree of particularity directed to the embodiments of the present invention. It should be appreciated, though, that the present invention is defined by the following claims construed in light of the prior art so modifications of the changes may be made to the exemplary embodiments of the present invention without departing from the inventive concepts contained therein.

What is claimed is:

1. A hole coring apparatus for creating a desired void in an earth surface, comprising:
(a) an open receptacle having a longitudinal axis, said open receptacle includes a surrounding sidewall positioned substantially symmetrical about said axis, said sidewall having a first open end and a second open end that are both substantially transverse to said axis to define a receptacle interior, said first open end having a perimeter that is less that a second open end perimeter;
(b) an extension member extending from a proximal end being adjacent to an exterior of said sidewall to a distal end, said extension member is substantially parallel to said axis;
(c) a driving member adjacent to said extension member positioned substantially transverse to said axis near said receptacle, said driving member is offset in relation to said extension member having a driving member long extension and an opposing driving member short extension, wherein said driving member long extension is longer than said driving member short extension; and
(d) a handle adjacent to said extension member positioned substantially transverse to said axis located between said driving member and said distal end, said handle is approximately co planar with said driving member, said handle is offset in relation to said extension member having a handle long extension and an opposing handle short extension, wherein said handle long extension is longer than said handle short extension such that said handle long extension is placed opposite of said driving member long extension in relation to said extension member.

2. A hole coring apparatus according to claim 1 wherein said surrounding sidewall is substantially elliptical in shape in a plane substantially perpendicular to said axis.

3. A hole coring apparatus according to claim 1 wherein said surrounding sidewall is substantially circular in shape in a plane substantially perpendicular to said axis.

4. A hole coring apparatus according to claim 1 wherein said surrounding sidewall is substantially square in shape in a plane substantially perpendicular to said axis.

5. A hole coring apparatus according to claim 1 wherein said surrounding sidewall is substantially rectangular in shape in a plane substantially perpendicular to said axis.

6. A hole coring apparatus according to claim 1 wherein said handle is constructed of round tube stock.

7. A hole coring apparatus according to claim 1 wherein said extension member is constructed of angle iron.

8. A hole coring apparatus according to claim 7 wherein said driving member is constructed of angle iron.

9. A hole coring apparatus according to claim 1 wherein said driving member is positioned to be substantially co planar with said second open end, wherein said driving member is operational to limit penetration of said open receptacle into the earth surface by said driving member contacting the earth surface.

10. A hole coring apparatus according to claim 1 wherein said first open end perimeter is formed into a leading edge blade to ease penetration of said open receptacle into the earth surface.

11. A method for creating a desired void in an earth surface with an operator manually using a hole coring apparatus, comprising the steps of:
(a) providing a hole coring apparatus that comprises an open receptacle with a longitudinal axis, an extension member extending from a proximal end being adjacent to said open receptacle to a distal end, said extension member is substantially parallel to said axis, a driving member adjacent to said extension member positioned transverse to said axis near said receptacle, said driving member is offset in relation to said extension member including a driving member long extension and an opposing driving member short extension, and a handle adjacent to said extension member positioned substantially transverse to said axis located between said driving member and said distal end, said handle is approximately co planar with said driving member, said handle is offset in relation to said extension member including a handle long extension and an opposing handle short extension, such that said handle long extension is placed opposite of said driving member long extension in relation to said extension member;
(b) positioning said open receptacle to a selected location on the earth surface where the desired void is to be located;
(c) placing a right foot of the operator upon said driving member long extension by bending a right knee of the operator, while leaving a left foot of the operator to remain on the earth surface by having a left leg extended of the operator wherein operator stability is enhanced;
(d) placing a left hand of the operator upon said handle long extension with a left arm of the operator extended;
(e) placing a right hand of the operator upon said short handle extension by bending a right arm elbow of the operator;
(f) applying a downward force by the operator simultaneously on the right foot of the operator upon said driving member long extension and a downward force on the left hand of the operator upon said handle long extension, wherein said open receptacle penetrates the earth surface with said axis being substantially perpendicular to the earth surface;
(g) continuing the downward force on the right foot and the left hand until said open receptacle penetrates the earth surface to a selected depth; and
(h) removing said hole coring apparatus from the earth surface by applying an upward force on said handle from the left and right hands of the operator, wherein the desired void is created in the earth's surface such that a cored earth plug is substantially retained by said open receptacle.

12. A method for creating a desired void in the earth surface according to claim 11 wherein said step of continuing the downward force is continued until said driving member contacts the earth surface.

13. A method for creating a desired void in the earth surface according to claim 11, wherein said step of continuing the downward force includes using both the right foot on said driving member long extension and the left foot on said driving member short extension, being operational to further increase the downward force.

14. A method for creating a desired void in an earth surface with an operator manually using a hole coring apparatus, comprising the steps of:
(a) providing a hole coring apparatus that comprises an open receptacle with a longitudinal axis, an extension member extending from a proximal end being adjacent to said open receptacle to a distal end, said extension member is substantially parallel to said axis, a driving member adjacent to said extension member positioned substantially transverse to said axis near said receptacle, said driving member is offset in relation to said extension member including a driving member long extension and an opposing driving member short extension, and a handle adjacent to said extension member positioned transverse to said axis located between said driving member and said distal end, said handle is approximately co planar with said driving member, said handle is offset in relation to said extension member including a handle long extension and an opposing handle short extension, such that said handle long extension is placed opposite of said driving member long extension in relation to said extension member;
(b) positioning said open receptacle to a selected location on the earth surface where the desired void is to be located;
(c) placing a left foot of the operator upon said driving member long extension by bending a left knee of the operator, while leaving a right foot of the operator to remain on the earth surface by having a right leg extended of the operator wherein operator stability is enhanced;
(d) placing a right hand of the operator upon said handle long extension with a right arm of the operator extended;
(e) placing a left hand of the operator upon said short handle extension by bending a left arm elbow of the operator;
(f) applying a downward force by the operator simultaneously on the left foot of the operator upon said driving member long extension and a downward force on the right hand of the operator upon said handle long extension, wherein said open receptacle penetrates the earth surface with said axis being substantially perpendicular to the earth surface;
(g) continuing the downward force on the left foot and the right hand until said open receptacle penetrates the earth surface to a selected depth; and
(h) removing said hole coring apparatus from the earth surface by applying an upward force on said handle from the left and right hands of the operator wherein the desired void is created in the earth's surface such that a cored earth plug is substantially retained by said open receptacle.

15. A method for creating a desired void in an earth surface according to claim 14, wherein said step of continuing the downward force is continued until said driving member contacts the earth surface.

16. A method for creating a desired void in an earth surface according to claim 14, wherein said step of continuing the downward force includes using both the left foot on said driving member long extension and the right foot on said driving member short extension, being operational to further increase the downward force.
